(19) United States
(12) Patent Application Publication
(10) Pub. No.: US 2010/0009170 A1
(43) Pub. Date: Jan. 14, 2010

(54) Conductive Floor Covering

(75) Inventors: Boris Wedel, Bietigheim-Bissingen (DE); Richard Eisele, Tamm (DE); Soren Willigeroth, Bietigheim-Bissingen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ARMSTRONG DLW AG

(21) Appl. No.: 12/306,381

(22) PCT Filed: Jun. 28, 2007
(86) PCT No.: PCT/EP07/05749

§ 371 Date: Aug. 6, 2009

(30) Foreign Application Priority Data
Jun. 29, 2006 (DE) 10 2006 029 963.9

(51) Int. Cl. H01B 1/12; C08F 2/46

(52) U.S. Cl. 428/328; 252/519.3; 427/487

(57) ABSTRACT

The present invention relates to a floor covering comprising an electrically conductive and/or anti-statically constructed substrate, the substrate containing at least one electrically conductive metal oxide and/or at least one electrically conductive organic polymer. Moreover, the present invention relates to a floor covering comprising a substrate and an electrically conductive and/or antistatic, transparent, radiation-cured or thermally cured finish based on an acrylic polymer, a method for finishing a floor covering at the plant comprising a substrate and an electrically conductive and/or antistatic, transparent, radiation-curable or heat-curable finish based on an acrylic polymer, as well as to such a finish.

The present invention relates to a floor covering comprising an electrically conductive and/or anti-statically constructed substrate, the substrate containing at least one electrically conductive metal oxide and/or at least one electrically conductive organic polymer. Moreover, the present invention relates to a floor covering comprising a substrate and an electrically conductive and/or antistatic, transparent, radiation-cured or thermally cured finish based on an acrylic polymer, a method for finishing a floor covering at the plant comprising a substrate, with an electrically conductive and/or antistatic, transparent, radiation-curable or heat-curable finish based on an acrylic polymer, as well as to such a finish.

Finishes are e.g. fluid substances which are applied in thin coating to objects and through chemical reaction and/or physical transformation form a solid film adhering to the objects, said film exhibiting protective and/or decorative functions. The application of finish to workpieces is referred to as varnishing. The main components of a finish are binders, solvents, fillers, lacquer auxiliaries and pigments. Acrylic polymer base finishes could be named here as an example.

Such acrylic polymer base finishes can be applied to floor coverings and cured/hardened by means of radiation or heat in order to improve the durability/fastness of such floor coverings. So that the design of such floor coverings is not optically impaired, as a rule a lacquer coating located over the design should be transparent.

For some years, plastic floor coverings, in particular PVC floor coverings have been increasingly sealed with acrylic polymer base finishes in order to lower the cleaning and restoration costs. Acrylic polymer seals are relatively resistant and can even be polishable in the case of the presence of wax portions.

If the finished floor covering is supposed to exhibit antistatic and/or electrically conductive properties or if it is preferably a case of an electrically conductive and/or antistatic floor covering, it is additionally necessary that the acrylic polymer finish is likewise electrically conductive and/or antistatic. However, if one uses conventional additives such as carbon black or metal powder in order to make such a finish conductive and/or antistatic, the optical appearance of such a coated floor covering is detrimentally influenced, since essentially there is no more transparency of the lacquer coating.

Hence the present invention is based on the object of providing a floor covering, comprising a substrate, which is constructed electrically conductive and/or antistatic, and a floor covering, comprising a substrate and a radiation or heat cured acrylic polymer finish, wherein the finish is supposed to be electrically conductive and/or antistatic and essentially transparent.

This problem is solved by the exemplary embodiments characterized in the claims.

In particular a floor covering, comprising an electrically conductive and/or antistatic constructed substrate, is provided, wherein the substrate contains at least one electrically conductive metal oxide and/or at least one electrically conductive organic polymer.

In addition a floor covering, comprising a substrate and an electrically conductive and/or antistatic, transparent, radiation or thermally cured acrylic polymer base finish is provided, wherein the finish contains at least one electrically conductive metal oxide and/or at least one electrically conductive organic polymer.

The finish can be applied in the floor covering of the present invention directly onto the substrate, or there can be further material layers, known to the person skilled in the art, between the substrate and the finish.

In accordance with the present invention the electrically conductive metal oxide can be selected from the group consisting of tin oxide, indium oxide, antimony oxide, aluminum oxide, titanium oxide, oxides of the rare earths and mixtures thereof. Such metal oxides can also be doped with other metals and/or semimetals.

The electrically conductive metal oxide can in accordance with the present invention also be present applied on one or more substrate materials. Suitable substrate materials comprise for example mica, barium sulfate, titanium oxide, silicon oxide, aluminum oxide and combinations thereof.

In one preferred exemplary embodiment of the present invention the electrically conductive metal oxide is antimony doped tin oxide. In this connection Minatec® 31 CM of the Merck company can be named as an example. In the case of Minatec® 31 CM mica is coated with a layer of antimony doped tin oxide.

In the case of the use of Minatec® 31 CM, i.e. light, electrically conductive pigments, in non-electrically conductive substrates like finish an electrical conductivity can only be achieved when a contact among the electrically conductive pigments in the non-electrically conductive matrix is guaranteed. In accordance with the present invention the matrix comprises the remaining components of the finish after application and curing. The supplemental amount is dependent on the pigment form and the type of pigment distribution in the matrix. The concentration in which the resistance of the application system severely decreases is called percolation PVC.

In accordance with the present invention along with or in place of the electrically conductive metal oxide electrically conductive organic polymers can also be used in the finishing of the floor covering. Examples of such polymers are polyanilines, polypyrroles, polyacetylenes, polythiophenes, derivatives of the preceding polymers and corresponding mixtures.

In accordance with the present invention the electrically conductive metal oxide is preferably used in a quantity of about 5 to about 25 percent by weight, more preferably of about 10 to about 20 percent by weight, even more preferably of about 10 to about 15 percent by weight and most preferably of about 15 percent by weight, based on the solid body of the binder in the finish.

Moreover the particles of the electrically conductive metal oxide preferably exhibit a size of less than about 60 μm, more preferably of less than about 30 μm, even more preferably of less than about 20 μm and most preferably of less than about 15 μm. A lower limit can in accordance with the present invention be specified for example at about 10 nm. One preferred range for the size of the particles of the electrically conductive metal oxide extends from about 10 to about 60 μm.

In the finish in accordance with the invention the solids are dispersed in the binder.

Any acrylic polymers can be used as binder in the finish in accordance with the invention. Examples of this are unsaturated urethane acrylate resins, polyester acrylates, polyether acrylates and epoxyacrylates, their derivatives and mixtures. Additionally solvents or diluents or dispersion agents can be contained in the finish in accordance with the invention, in which the binder dissolves or disperses, in order to put the finish in a better applicable form. As solvents or diluents or dispersion agents ether alcohols, aliphatics, alcohols (“spirit”), aromatics, chlorinated hydrocarbons, esters, hydroaromatics, ketones, terpene hydrocarbons and water can be used in the finish of the present invention. Aromatics, esters, ketones, water and their mixtures are in accordance with the present invention preferred as solvents, diluents or dispersion agents.

In accordance with the present invention the finish is radiation or heat-curable. The curing of applied finishes in liquid state to stable surface coatings is referred to as finish curing. This finish curing takes place in accordance with the present invention as radiation curing for example by ultraviolet (UV) or ionizing radiation, as thermal curing for example by oven or infrared drying. For the UV cross-linking, in which the mercury vapor lamps are preferably used as light sources within the framework of the present invention, preferably acrylic components can be cured or cross-linked in the finish in accordance with the invention. Examples of this are unsaturated urethane acrylate resin, polyester acrylates, polyether acrylates and epoxyacrylates, their derivatives and mixtures thereof. Especially preferred in this connection is a corresponding combination of the foregoing named acrylate resins with tripropylene glycol diacrylate, 1,6-hexanediol diacrylate and dipropylene diglycol acrylate. So that the curing or cross-linking of the finish with acrylic components in accordance with the invention can take place, the corresponding finish composition should comprise photo-initiators on the basis of benzophenone derivatives or thioxanthones or other common initiators. In this connection benzophenone is especially preferred. In accordance with the present invention a finish with the following composition is most preferred: about 20 to about 35 percent by weight acrylic oligomers, about 35 to about 50 percent by weight acrylic monomers, about 4 to about 7 percent by weight additives, about 10 to 20 percent by weight fillers (wherein here too the inventive electrically conductive metal oxides and/or electrically conductive organic polymers are contained) and about 1 to about 5 percent by weight photo-initiators.

In addition the inventive finish can contain additives such as for example defoamers, deaerators, wetting and dispersing agents, surface additives, rheology additives, thixotroping agents, light-stability agents, radical interceptors, catalysts or accelerators, biocides, dulling agents and dispersing agents or anti-settling agents.

For example, aliphatic mineral oil, water-repellent silicic acid, polyurea compounds, dimethylpolysiloxanes, polysiloxanes and specially modified siloxanes can be used in the finish of the present invention as defoamers.

In addition in accordance with the present invention deaerators such as for example special organic polymers, such as polyethers or polyacrylates, dimethylpolysiloxanes, polysiloxanes and specially modified siloxanes and fluorosilicones can be contained in the finish composition.

In addition, wetting and dispersing agents such as for example tensides, polyphosphates or polyacrylates, surface additives such as for example tensides, fluorinated compounds, silicon oils, modified polysiloxanes and acrylate copolymers, rheology additives (thickening agents) such as for example cellulose derivatives, derivatives of heteropolysaccharides, polyacrylates, polyether polyols and polyurethane derivatives, thixotroping agents such as for example modified phyllosilicates, pyrogenic silicic acids, polyurea derivatives and derivatives of hydrated castor oil can be contained in the inventive finish.

Serving as light-stability agents in accordance with the invention for example are UV absorbers such as 2-hydroxybenzophenones, 2-hydroxyphenylbenzotriazoles, 2-hydroxyphenyl triazines and oxalanilides, while serving as radical interceptors for example are 2,2,6,6-tetramethylpiperidine and chelate complexes of transition metals.

In addition catalysts or accelerators can be contained in the finish of the present invention such as for example organic peroxides, e.g. benzoyl peroxides or 2-butanone peroxides.

Serving as biocides in accordance with the present invention are for example N-heterocycles, S-heterocycles, isothiazolone, chloracetamide, dithiocarbamate, thiophthalimide derivatives, benzimidazol derivatives and trialkyl tin compounds.

Finally the finish in accordance with the invention can also contain dulling agents such as for example pigments, fillers, precipitation silicic acids and PE waxes. Serving as fillers in the process for example are silica gels, Blancfix (barium sulfate), diatomite and talcum, while serving as pigments for example are oxidic pigments such as for example titanium oxide, iron oxide red, iron oxide black, chrome oxide green, or organic pigments such as for example azo, phthalocyanine and triarylmethane pigments.

Dispersing agents or anti-settling agents used with in the scope of the present invention contribute to prevent the dispersed particles in the applied finish from settling, which along with an improved storage capacity also contributes to a homogeneous distribution of the particles to the inventive floor covering with finish. Examples of such dispersing agents or anti-settling agents are solutions of polycarboxylic salts of polyamineamides, solutions of high-molecular block copolymers with pigment affine groups, higher-molecular unsaturated polycarboxylic acids, siloxane copolymers, derivatives thereof and corresponding mixtures.

Preferably the thickness of the dry coating of the finish of the inventive floor covering is about 5 to about 200 μm, more preferably about 10 to about 150 μm, even more preferably about 15 to about 60 μm, and most preferably about 15 to about 20 μm. In the process the dry coating of the finish of the inventive floor covering can be constructed as a single or multiple layer system, wherein the individual layers can be constructed as described above.

The floor covering used according to the invention as “substrate” for the finish coating is not subject to any restrictions. It can comprise any material known as state of the art, and is additionally equipped as antistatic and/or electrically conductive or can additionally be equipped as antistatic and/or electrically conductive. Preferably PVC, linoleum, rubber, polyolefin-, polyurethane coverings or a floor covering made of renewable raw materials are used as floor coverings.

By the term used here “PVC” one understands a polyvinyl chloride obtainable by conventional polymerization methods, such as suspension polymerization (S-PVC), emulsion polymerization (E-PVC) and substance or mass polymerization (M-PVC).

PVC based flexible or elastic floor coverings contain plasticizer containing PVC as a binder and conventional additives such as fillers, colorants, such as pigments and organic and inorganic dyes, and auxiliaries.

Further the floor coverings can contain conventional auxiliaries, such as for example antioxidants, antistatics, stabilizers, UV absorbers, blowing agents, adhesives, fungicides, lubricants and processing auxiliaries in the usual quantities.

Alternatively the inventive floor covering can also be constructed on a linoleum basis. The linoleum comprises in the process conventional components such as binders (so-called Bedford cement or B cement from a partially oxidized linseed oil and at least one resin as tackifying agent), at least one filler and if applicable at least one colorant. As fillers conventionally soft wood flour and/or cork powder (in the case of the simultaneous presence of wood flour and cork powder typically in the weight ratio 90:10) and/or chalk, kaolin (china clay), diatomite and barite. Additionally precipitated silicic acid and slight quantities of water glass, for example water glass in a quantity of up to 15 percent by weight based on the quantity of the layer, can be added as filler for stiffening of the mass.

In addition the inventive floor covering can also be formed of renewable raw materials such as for example epoxidizing products of carboxylic acid esters. In this connection reference is made for example to DE 195 42 274 A1, which discloses sheet material made of renewable raw materials.

The inventive floor covering on for example PVC or linoleum basis or on the basis of renewable raw materials can be constructed electrically conductive e.g. by the addition of at least a derivative of the imidazole, imidazoline, benzimidazole or morpholine or a cationic compound such as a quaternary ammonium salt, e.g. tetraalkyl ammonium salt, (see DE 34 16 573 and WO 99/10592) and/or by the arrangement of a layer on for example a PVC, linoleum, rubber, polyolefin, polyurethane basis or on the basis of renewable raw materials, which contains at least one electrically conductive filler, for example carbon black or metal powder.

In the foregoing connection in accordance with the present invention an electrically conductive metal oxide from the group consisting of tin oxide, indium oxide, antimony oxide, aluminum oxide, titanium oxide, oxides of the rare earths and mixtures thereof can be present in the inventive floor covering. Such metal oxides can also be doped with other metals and/or semimetals.

The electrically conductive metal oxide can in accordance with the present invention also be present applied on one or more substrate materials. Suitable substrate materials comprise for example mica, barium sulfate, titanium oxide, silicon oxide, aluminum oxide and combinations thereof.

In one preferred exemplary embodiment of the present invention the electrically conductive metal oxide is antimony doped tin oxide. In this connection Minatec® 31 CM of the Merck company can be named as an example. In the case of Minatec® 31 CM mica is coated with a layer of antimony doped tin oxide. In accordance with the present invention along with or in place of the electrically conductive metal oxide electrically conductive organic polymers can also be used in the finishing of the floor covering. Examples of such polymers are polyanilines, polypyrroles, polyacetylenes, polythiophenes, derivatives of the preceding polymers and corresponding mixtures.

The inventive floor coverings are suitable for use in hospitals, for example in operation rooms, in radiology, in laboratories and supply rooms. In addition the inventive floor coverings can be used in the industrial sector for example in computer rooms, in clean rooms and in electronic departments.

In addition the present invention provides a method for the finishing of a floor covering at the plant, comprising a substrate, with a finish described above, comprising the steps of the application of the finish on the topside of the floor covering and of radiation or thermal curing of the finish.

The application of the finish on the topside of the floor covering at the plant can take place in accordance with the present invention by coating, spraying with the help of spray units (e.g. compressed air, electrostatic acting, airless and hot spray guns), by flow coating, dipping, curtain coating or rolling. In accordance with the method of the present invention the application by rolling is particularly preferred. In accordance with the method of the present invention the curing of the finish at the plant takes place with radiation or thermally. The curing of finishes applied in liquid state to stable surface coatings is, also already described above, referred to as finish curing. In the method of the present invention in the process in the case of UV curing preferably mercury vapor lamps are used as light sources.

In addition the present invention provides the finish described above.

Finally the present invention provides the use of a finish described above for the finishing of floor covering at the plant.

In accordance with the present invention among other things a floor covering is provided with an acrylic polymer base electrically conductive and/or antistatic, transparent, radiation cured or thermally cured finishing, wherein the finish contains at least one electrically conductive metal oxide and/or at least one electrically conductive organic polymer. In contrast to pure UV finishes, which constitute isolators, a corresponding finish layer on a floor covering is electrically conductive and/or antistatic. Through the special use of for example metal oxides such as mica, coated with antimony doped tin oxide, in contrast to the electrically conductive rendering additives used up to now, the finish coating remains transparent and with this also the attractive appearance of a corresponding floor covering is preserved. Simultaneously the inventively used metal oxides are not water soluble and with this do not impair the cleanability of a corresponding floor covering. If the floor covering thus finished itself is electrically conductive and/or antistatic, the inventive finish does not impair the corresponding properties of the floor covering through its own electrical conductivity and/or antistatic properties.

### EXAMPLES

In each of the following examples an inventive finish of the following composition is used:

| | |
|---|---|
| Acrylic oligomers | about 20 to about 35 percent by weight |
| Acrylic monomers | about 35 to about 50 percent by weight |
| Additives | about 4 to about 7 percent by weight |
| Fillers (including the inventive | about 10 to 20 percent by weight |
| electrically conductive metal | |
| oxides and/or electrically | |
| conductive organic polymers) | |
| Photo-initiators | about 1 to about 5 percent by weight |

In addition in each of the following examples a homogeneous, conductive PVC floor covering of the following composition was used:

| | |
|---|---|
| PVC | about 20 to about 60 percent by weight, |
| | preferably about 45 to about 50 percent |
| | by weight |
| Plasticizers | about 10 to about 40 percent by weight, |
| | preferably about 16 to about 20 percent |
| | by weight |
| Fillers (e.g. chalk, marble flour) | about 15 to about 60 percent by weight, |
| | preferably about 25 to about 30 percent |
| | by weight |
| Pigments, (free of heavy metals, including the | about 1 to about 15 percent by weight, |
| electrically conductive agents named in the | preferably about 1 to about 5 percent |
| foregoing description such as e.g. carbon black) | by weight |
| Stabilizers (free of lead and cadmium) | about 0.5 to about 1.5 percent by weight, |
| | preferably about 0.5 to about 1 percent |
| | by weight |
| Lubricants | <about 1 percent by weight |

### Example 1

A homogeneous, conductive PVC floor covering was finished with an electrically conductive, transparent, UV curable polyurethane base finish. Subsequently the electric behavior of the finished floor covering thus obtained was determined and compared with the electric behavior of the same floor covering without the inventive finishing. The results can be summarized as follows:

| | | | | unfinished |
|---|---|---|---|---|
| | DIN EN 1081 | | | sample |
| | Measuring voltage | V | 100 | 100 |
| Leak resistance, R₁ | Median | Ohm | 3.0E+05 | 1.1E+05 |
| at 23° C./50% r.F. | Single value | Ohm | 3.0E+05 | 1.1E+05 |
| | | Ohm | 2.9E+05 | 1.4E+05 |
| | | Ohm | 4.3E+05 | 8.2E+04 |
| Leak resistance, IEC 61340-4-1 | Median | Ohm | 6.6E+05 | 2.6E+05 |
| Measuring voltage 100 V | Single value | Ohm | 6.6E+05 | 1.4E+05 |
| at 23° C./50% r.F. | | Ohm | 6.2E+05 | 2.6E+05 |
| | | Ohm | 8.1E+05 | 3.4E+05 |
| Measuring voltage 100 V | Median | Ohm | 9.1E+05 | 2.0E+05 |
| at 23° C./25% R.H. | Single value | Ohm | 9.9E+05 | 1.5E+05 |
| | | Ohm | 7.1E+05 | 2.0E+05 |
| | | Ohm | 9.1E+05 | 6.1E+05 |
| Leak resistance, referring to | Median | Ohm | 5.8E+05 | 2.0E+05 |
| IEC 61340-4-1 | Single value | Ohm | 4.9E+05 | 1.1E+05 |
| For the measurement of the leak | | Ohm | 5.8E+05 | 2.0E+05 |
| resistance a damp cloth is placed | | Ohm | 1.0E+06 | 2.0E+05 |
| under the sample on the metal plate | | | | |
| Measuring voltage 100 V | | | | |
| at 23° C./25% R.H. | | | | |
| Measuring voltage 100 V | Median | Ohm | 8.3E+05 | 2.2E+05 |
| at 23° C./25% R.H. | Single value | Ohm | 8.3E+05 | 1.2E+05 |
| | | Ohm | 5.0E+05 | 2.3E+05 |
| | | Ohm | 1.3E+06 | 2.2E+05 |
| Location transition resistance | VDE 0100 | | | |
| | Median value | kOhm | 50 | <43 |
| Walk test | DIN EN 1815 | | | |
| insulating underlay | Rubber sole | kV | 0.6 | 0.2 |
| | PVC sole | kV | 0.6 | 0.2 |
| | Neolite sole | kV | 1.3 | 0.2 |
| antistatic underlay | Rubber sole | kV | 0.6 | 0.1 |
| | PVC sole | kV | 0.4 | 0.1 |
| | Neolite sole | kV | 1.4 | 0.4 |

| | |
|---|---|
| Requirement in resistance | Rubber sole 10⁸ to 10⁹ Ohm |
| of the test soles | PVC sole 10¹¹ to 10¹² Ohm |
| | Neolite sole 10¹⁰ to 10¹¹ Ohm |

### Example 2

A homogeneous, conductive PVC floor covering was finished with an electrically conductive, transparent, UV curable polyurethane bare finish. Subsequently the electric behavior of the finished floor covering thus obtained was determined and compared with the electric behavior of the same floor covering without the inventive finishing. The results can be summarized as follows:

| | | | | unfinished |
|---|---|---|---|---|
| | DIN EN 1081 | | | sample |
| | Measuring voltage | V | 100/500*) | 100/500*) |
| Leak resistance, R₁ | Median | Ohm | 5.1E+05 | 3.1E+05 |
| at 23° C./50% R.H. | Single value | Ohm | 5.1E+05 | 9.5E+05*) |
| | | Ohm | 1.3E+06*) | 2.5E+05 |
| | | Ohm | 6.3E+05 | 3.1E+05 |
| Leak resistance, IEC 61340-4-1 | Median | Ohm | 3.8E+06 | 3.2E+06 |
| Measuring voltage 100 V | Single value | Ohm | 3.0E+06 | 4.0E+06 |
| at 23° C./50% R.H. | | Ohm | 5.0E+06 | 2.2E+06 |
| | | Ohm | 3.8E+06 | 3.2E+06 |
| Measuring voltage 100 V | Median | Ohm | 4.0E+06 | 3.4E+06 |
| at 23° C./25% R.H. | Single value | Ohm | 4.0E+06 | 3.8E+06 |
| | | Ohm | 4.5E+06 | 2.3E+06 |
| | | Ohm | 1.6E+06 | 3.4E+06 |
| Leak resistance, referring to | Median | Ohm | 3.0E+06 | 2.0E+06 |
| IEC 61340-4-1 | Single value | Ohm | 3.0E+06 | 2.7E+06 |
| For the measurement of the leak | | Ohm | 3.3E+06 | 2.0E+06 |
| resistance a damp cloth is placed | | Ohm | 2.3E+06 | 1.21E+06 |
| under the sample on the metal plate | | | | |
| Measuring voltage 100 V | | | | |
| at 23° C./50% R.H. | | | | |
| Measuring voltage 100 V | Median | Ohm | 4.2E+06 | 2.2E+06 |
| at 23° C./25% R.H. | Single value | Ohm | 4.2E+06 | 1.8E+06 |
| | | Ohm | 4.4E+06 | 2.2E+06 |
| | | Ohm | 2.7E+06 | 2.4E+06 |
| Location transition resistance | VDE 0100 | | | |
| | Median value | kOhm | 120 | 55 |
| Walk test | DIN EN 1815 | | | |
| insulating underlay | Rubber sole | kV | 0.5 | 0.4 |
| | PVC sole | kV | 0.5 | 0.4 |
| | Neolite sole | kV | 1.1 | 0.2 |
| antistatic underlay | Rubber sole | kV | 0.6 | 0.3 |
| | PVC sole | kV | 0.4 | 0.2 |
| | Neolite soles | kV | 1.1 | 0.2 |

| | |
|---|---|
| Requirement in resistance | Rubber sole 10⁸ to 10⁹ Ohm |
| of the test sole | PVC sole10¹¹ to 10¹² Ohm |
| | Neolite sole 10¹⁰ to 10¹¹ Ohm |

With the help of the foregoing cited measuring results it is clear that the correspondingly determined resistance in the comparison of the unfinished and finished floor coverings only slightly increases, and hence the electric conductivity of a floor covering finished with a finish in accordance with the present invention remains preserved. The inventive floor coverings cited in Examples 1 and 2 showed essentially the same material properties as unfinished floor coverings and fulfilled in particular the requirements under DIN EN 649 and are suitable for example under DIN EN 685 for use in hospitals such as for example in operating rooms, in radiology, laboratories and supply rooms. In addition the inventive floor coverings can be used in the industrial sector for example in computer rooms, in clean rooms and in electronic departments.

1. A floor covering comprising an electrically conductive and/or anti-statically constructed substrate, the substrate containing at least one electrically conductive metal oxide and/or at least one electrically conductive organic polymer.

2. The floor covering according to claim 1, wherein the electrically conductive metal oxide is selected from the group consisting of tin oxide, indium oxide, antimony oxide, aluminum oxide, titanium oxide, oxides of the rare earths and mixtures thereof.

3. The floor covering according to claim 1, wherein the electrically conductive metal oxide is antimony doped tin oxide.

4. The floor covering according to claim 1, wherein the electrically conductive metal oxide is mica with a layer of antimony doped tin oxide.

5. A floor covering comprising a substrate and an electrically conductive and/or antistatic, transparent, radiation-cured or thermally cured finish based on an acrylic polymer, wherein the finish contains at least one electrically conductive metal oxide and/or at least one electrically conductive organic polymer.

6. The floor covering according to claim 5, wherein the electrically conductive metal oxide is selected from the group consisting of tin oxide, indium oxide, antimony oxide, aluminum oxide, titanium oxide, oxides of the rare earths and mixtures thereof.

7. The floor covering according to claim 5, wherein the electrically conductive metal oxide is antimony doped tin oxide.

8. The floor covering according to claim 5, wherein the electrically conductive metal oxide is mica with a layer of antimony doped tin oxide.

9. The floor covering according to claim 5, wherein the electrically conductive metal oxide is present in a proportion of 5 to 25 percent by weight, related to the solid body of the binder in the finish.

10. The floor covering according to claim 5, wherein the particles of the electrically conductive metal oxide exhibit a size of less than 60 μm.

11. The floor covering according to claim 5, wherein the thickness of the finish is 5 to 200 μm.

12. The floor covering according to claim 5, wherein the substrate for the finish comprises PVC, linoleum, rubber, polyolefin, polyurethane renewable raw materials.

13. The floor covering according to claim 12, wherein the substrate for the finish comprises about 20 to about 60 percent by weight PVC, about 10 to about 40 percent by weight plasticizers, about 15 to about 60 percent by weight fillers, about 1 to about 15 percent by weight pigments, about 0.5 to about 1.5 percent by weight stabilizers and <about 1 percent by weight lubricants.

14. The floor covering according to claim 5, wherein the substrate for the finish itself is constructed electrically conductive and/or antistatic.

15. The floor covering according to claim 14, wherein the substrate for the finish contains at least one electrically conductive metal oxide and/or at least one electrically conductive organic polymer.

16. The floor covering according to claim 15, wherein the electrically conductive metal oxide is selected from the group consisting of tin oxide, indium oxide, antimony oxide, aluminum oxide, titanium oxide, oxides of the rare earths and mixtures thereof.

17. The floor covering according to claim 15, wherein the electrically conductive metal oxide is antimony doped tin oxide.

18. The floor covering according to claim 15, wherein the electrically conductive metal oxide is mica with a layer of antimony doped tin oxide.

19. A method for the finishing of a floor covering at the plant, comprising a substrate, with an electrically conductive and/or antistatic, transparent, radiation-curable or thermally cured finish based on an acrylic polymer according to claim 5, comprising the steps
of application of the finish on the topside of the floor covering and
of thermal curing of the finish or curing of the finish with radiation.

20. The method according to claim 19, wherein the application of the finish takes place by rolling.

21. An electrically conductive and/or antistatic, transparent, radiation-curable or heat-curable finish based on an acrylic polymer for the finishing of a floor covering according to claim 5, wherein the finish contains at least one electrically conductive metal oxide and/or at least one electrically conductive organic polymer.
